(19) United States
(12) Patent Application Publication
(10) Pub. No.: US 2003/0118211 A1
(43) Pub. Date: Jun. 26, 2003

(54) Watermark information extraction apparatus and method of controlling thereof

(75) Inventors: Takami Eguchi, Tokyo (JP); Keiichi Iwamura, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/322,713

(22) Filed: Dec. 19, 2002

(30) Foreign Application Priority Data
Dec. 25, 2001 (JP) 2001-392641
Nov. 21, 2002 (JP) 2002-338108

(51) Int. Cl. G06K 9/00; G06K 9/36

(52) U.S. Cl. 382/100; 382/232

(57) ABSTRACT

Disclosed are a watermark information extraction apparatus and method of controlling thereof having an extraction accuracy equal to or greater than that of the conventional technique, which performs extraction using an original image, without requiring use of an original image when extracting watermark information that has been embedded in an image by a digital watermark. A verification image (100) in which watermark information has been embedded by a digital watermark is input from an input unit (101). Character information concerning a prescribed character included in the verification image (100) is acquired by a recognition processor (102) utilizing a recognition dictionary (103). On the basis of the character information acquired, an original image (105) that prevailed prior to the embedding of watermark information is reconstructed by a original image reconstruction unit (104). A watermark information extraction unit (106) extracts watermark information (107) based upon a difference component between a prescribed character in the reconstructed original image (105) and the prescribed character in the verification image (100).

### FIELD OF THE INVENTION

This invention relates to a watermark information extraction apparatus for extracting watermark information from an image in which watermark information has been embedded by a digital watermark, and to a method of controlling this apparatus.

### BACKGROUND OF THE INVENTION

Though the electronification of documents has been promoted in recent years, the distribution of document information is still in many cases implemented in the form of printed documents. Since joint use is thus made of documents in electronic form and documents in printed form, control at the destination at which documents are distributed is sought when electronic documents are distributed as printed documents, and so are means for linking printed documents and electronic documents. In view of these circumstances, a technique for embedding watermark information in document information by a digital watermark has been proposed. (For example, see the specification of Japanese Patent No. 3136061.)

The embedding of information by a digital watermark signifies means for embedding watermark information by altering a portion of original data. For example, altering an embedded character such as by enlarging or reducing the size thereof, rotating the character and partially emphasizing the character can be mentioned as means for embedding watermark information using a digital watermark applied to a character. Using such a digital watermark is advantageous in that is allows document metadata and the document creator to be placed in an inseparable relationship.

FIG. 18 is a diagram useful in describing characters in a case where watermark information has been embedded by a digital watermark based upon an enlargement or reduction in the size of characters. For example, a “1” is embedded (A in FIG. 18) if the size of the character has been made larger than that of the original character, and a “0” is embedded (B in FIG. 18) if the size of the character has been made smaller than that of the original character. It should be noted that characters to be embedded may be successive characters, characters over an interval of several characters or characters at predetermined positions. In FIG. 18, the “ [symbol] ” character has been enlarged and the “ [symbol] ” character has been reduced, and therefore watermark information “10” has been embedded.

FIG. 19 is a diagram useful in describing characters in a case where watermark information has been embedded by a digital watermark based upon tilting of characters by rotating the same. For example, a “1” is embedded (C in FIG. 19) if the size of the character has been rotated clockwise, and a “0” is embedded (B in FIG. 18) if the character has been rotated counter-clockwise. It should be noted that characters to be embedded may be successive characters, characters over an interval of several characters or characters at predetermined positions. In FIG. 19, the character “ [symbol] ” has been rotated clockwise and the character “ [symbol] ” has been rotated counter-clockwise, and therefore watermark information “10” has been embedded.

FIG. 20 is a diagram useful in describing characters in a case where watermark information has been embedded by a digital watermark based upon emphasis of the feature of a part of a character. For example, a “1” is embedded (the portion E in FIG. 20) if the radical of the character has been elongated, and a “0” is embedded (the portion F in FIG. 20) if the radical of the character has been shortened. It should be noted that characters to be embedded may be successive characters, characters over an interval of several characters or characters at predetermined positions. In FIG. 20, the first stroke of the character “ [symbol] ” has been elongated and the second stroke of the character “ [symbol] ” has been shortened, and therefore watermark information “10” has been embedded.

Methods of extracting watermark information that has been embedded by a digital watermark include a method that requires an original image and a method that does not. FIG. 21 is a block diagram illustrating the structure of a prior-art apparatus that uses an original image to extract watermark information that has been embedded by a digital watermark. In the apparatus of FIG. 21, a verification image 210 in which watermark information has been embedded by a digital watermark is input to a watermark information extraction unit 211. The latter extracts watermark information 214 utilizing an original image 212 that prevailed prior to embedding of the watermark information by the digital watermark.

There are also cases where key information 213 is utilized to extract the watermark information 214. In general, position information relating to watermark information that has been embedded by a digital watermark can be hidden from a third party by utilizing key information when extracting watermark information. Further, in one known method of extracting watermark information, the difference between a verification image and an original image is calculated and the watermark information is distinguished based upon the value of the difference. (For example, see the specification of Japanese Patent Application Laid-Open No. 10-276321.)

Since the method of extracting watermark information using an original image makes it possible to pursue the degree to which a verification image in which watermark information has been embedded differs from the original image, a digital watermark can be implemented with a high degree of extraction precision.

However, problems which arise with a method that uses an original image to extract watermark information are the complexity involved in storing the original image and the necessity for a storage device, namely the need for resources required in order to store the original image. Further, labor is involved in identifying whether the original image used when extracting watermark information is the original image or the verification image. Furthermore, if the verification image is distributed via a medium or is changed in the process of being distributed, then the watermark information cannot be extracted accurately.

### SUMMARY OF THE INVENTION

The present invention has been proposed to solve the aforementioned problems of the prior art and has as its object to provide a watermark information extraction apparatus and method of controlling thereof having an extraction accuracy equal to or greater than that of the conventional technique, which performs extraction using an original image, without requiring use of an original image when extracting watermark information that has been embedded in an image by a digital watermark.

According to the present invention, the foregoing object is attained by providing a watermark information extraction apparatus comprising input means for inputting a document image in which digital watermark information has been embedded; character recognition means for recognizing each character image constituting the document image; and digital watermark detection means for detecting the digital watermark information, which has been embedded in each character image constituting the document image, based upon a standard shape of each character that has been recognized.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the structure of a watermark information extraction apparatus according to a first embodiment of the present invention;

FIG. 2 is a conceptual view useful in describing a digital watermark extraction apparatus that does not use an original image;

FIG. 3 is a block diagram illustrating the components of a recognition processor;

FIG. 4 is a block diagram illustrating the components of an original image reconstruction unit;

FIG. 5 is a block diagram illustrating the components of a watermark information extraction unit;

FIG. 6 is a flowchart useful in describing an example of a procedure for creating a verification image used in the first embodiment;

FIG. 7 is a flowchart useful in describing the operation of the watermark information extraction apparatus according to the first embodiment;

FIG. 8 is a flowchart useful in describing the operation of the recognition processor shown in FIG. 7;

FIG. 9 is a flowchart useful in describing the operation of the original image reconstruction unit according to the first embodiment;

FIG. 10 is a flowchart useful in describing the operation of the watermark information extraction unit according to the first embodiment;

FIG. 11 is a block diagram illustrating the structure of a watermark information extraction apparatus according to a second embodiment of the present invention;

FIG. 12 is a flowchart useful in describing an example of a digital watermark embedding method that alters the relative size of a character in order to create a verification image;

FIG. 13 is a flowchart useful in describing the operation of the watermark information extraction apparatus having the above-described structure;

FIG. 14 is a block diagram illustrating the structure of a watermark information extraction apparatus according to a third embodiment of the present invention;

FIG. 15 is a flowchart useful in describing an example of a digital watermark embedding method that changes the inclination of a character for creating a verification image;

FIG. 16 is a flowchart useful in describing the operation of the watermark information extraction apparatus having the above-described structure;

FIG. 17 is a diagram useful in describing the electrical structure of a watermark information extraction apparatus according to four embodiments of the present invention;

FIG. 18 is a diagram useful in describing characters in a case where watermark information has been embedded by a digital watermark based upon enlargement or reduction of the size of characters;

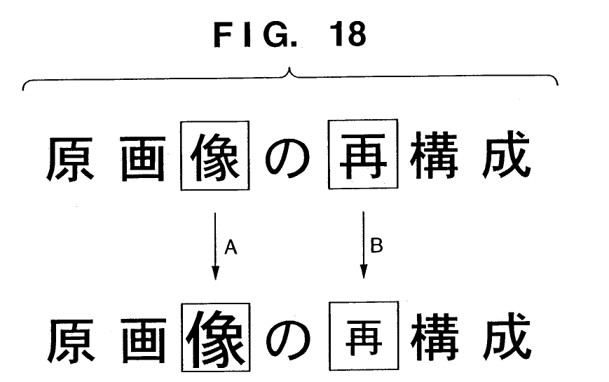

FIG. 19 is a diagram useful in describing characters in a case where watermark information has been embedded by a digital watermark based upon a change in inclination achieved by rotating characters;

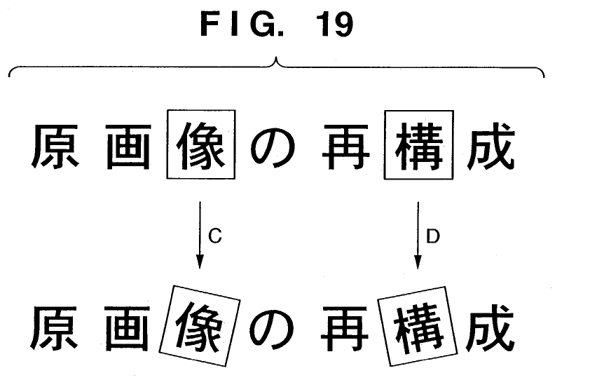

FIG. 20 is a diagram useful in describing characters in a case where watermark information has been embedded by a digital watermark based emphasis of the feature of a part of a character;

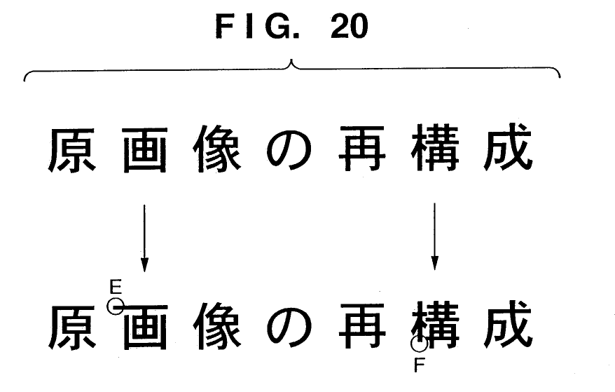

FIG. 21 is a block diagram illustrating the structure of a prior-art apparatus that uses an original image to extract watermark information embedded by a digital watermark;

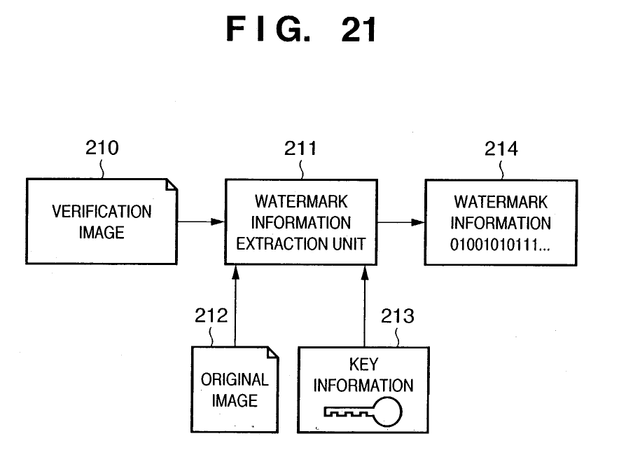

FIG. 22 is a block diagram illustrating the structure of a watermark information extraction apparatus according to a fourth embodiment of the present invention;

FIG. 23 is a block diagram illustrating the components of an original image reconstruction unit according to the fourth embodiment;

FIG. 24 is a flowchart useful in describing the operation of the watermark information extraction apparatus according to the fourth embodiment; and

FIG. 25 is a flowchart useful in describing the operation of the original image reconstruction unit according to the fourth embodiment.

### DESCRIPTION OF THE PREFERRED EMBODIMENTS

Preferred embodiments of the present invention will now be described in detail in accordance with the accompanying drawings.

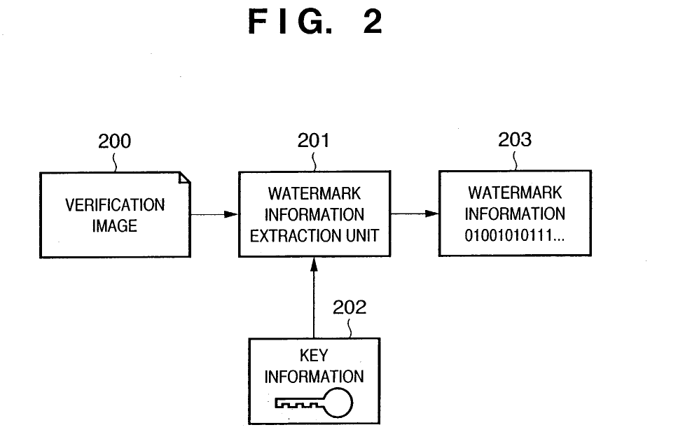

FIG. 2 is a conceptual view useful in describing a digital watermark extraction apparatus that does not use an original image. As shown in FIG. 2, a verification image 200 in which watermark information has been embedded by a digital watermark is input to a watermark information extraction unit 201. The watermark information extraction unit 201 extracts watermark information 203 using only the entered verification image 200 or utilizing key information 202.

<First Embodiment>

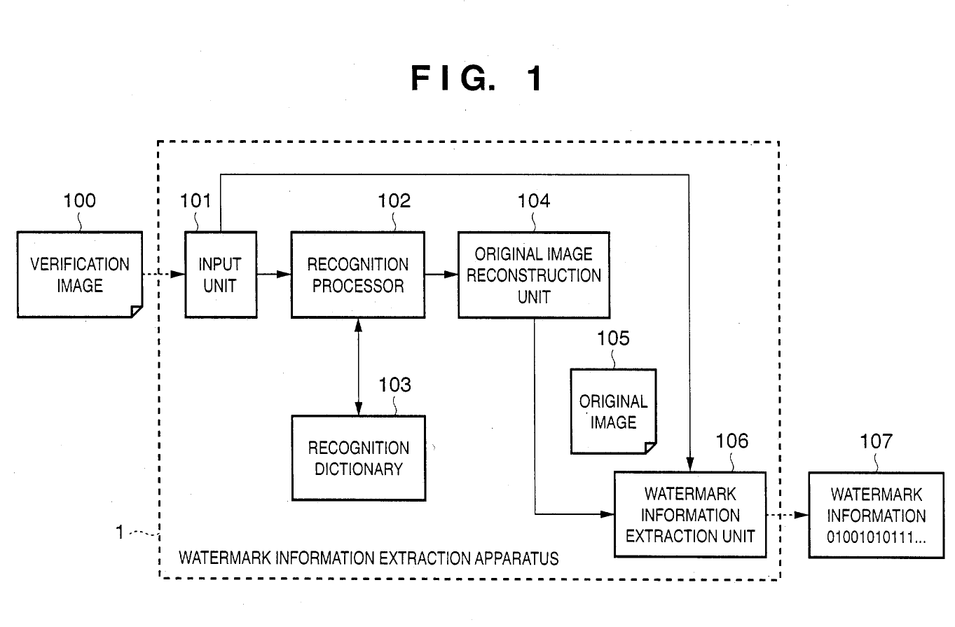

FIG. 1 is a block diagram illustrating the structure of a watermark information extraction apparatus 1 according to a first embodiment of the present invention. As shown in FIG. 1, a verification image 100 is a document image in which watermark information 107 has been embedded in a certain document image by a digital watermark. Portions of several characters in this document image have been changed in shape. The watermark information extraction apparatus 1 according to this embodiment extracts the watermark information 107 from the verification image 100.

The watermark information extraction apparatus 1 according to the first embodiment comprises a recognition processor 102 for recognizing character code information, font information and character position information by performing character recognition within the verification image 100 entered from an input unit 101; a recognition dictionary 103, which is a dictionary used in character recognition performed by the recognition processor 102; an original image reconstruction unit 104 for generating an original image that prevailed prior to embedding of the watermark information 107 to be extracted based upon results of character recognition; and a watermark information extraction unit 106 for extracting the watermark information 107 utilizing the entered verification image 100 and an original image 105 that has been generated.

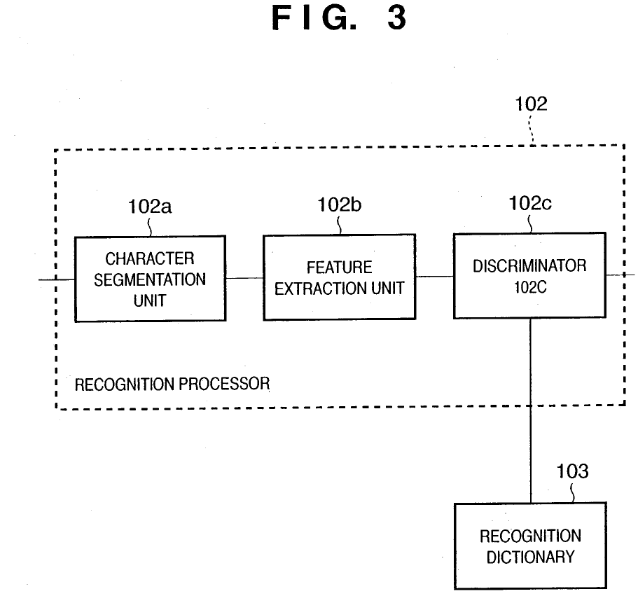

FIG. 3 is a block diagram illustrating the components of the recognition processor 102. In this embodiment, it is assumed that the recognition processor 102 performs character recognition by optical character recognition (OCR). Using OCR techniques makes it possible to identify characters even from a document image in which the size of characters has been changed, characters have been rotated slightly or the features of part of a character have been emphasized. Identification not only of character information but also of multiple fonts is possible (see “An Introduction to Character Recognition” by Shinichiro Hashimoto, Denshi Tsushin Kyokaikan).

Accordingly, it is possible to recognize characters irrespective of character feature emphasis, a change in character size or character rotation that has been applied to an original image at the time of embedding of watermark information by a digital watermark. The original image that prevailed before the embedding of the watermark information can be reconstructed using the recognized characters.

The recognition processor 102 includes a character segmentation unit 102a for cutting a character from the verification image 100 using the circumscribed rectangle of the character as the minimum unit of character recognition; a feature extraction unit 102b for extracting a feature that includes position information relating to the segmented character; and a discriminator 102c for identifying character code information and font information by comparing the feature of the character and the features of characters or fonts stored in a recognition dictionary 103.

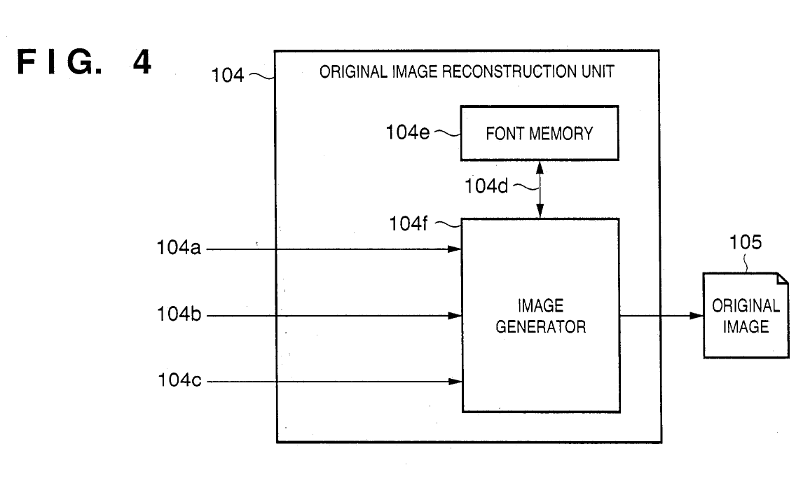

FIG. 4 is a block diagram illustrating the components of the original image reconstruction unit 104. The original image reconstruction unit 104 includes an image generator 104f, to which is input character code information 104a, font information 104b and character position information 104c obtained from the recognition processor, for generating an original image 105 using character font data 104d that has been stored in a font memory 104e.

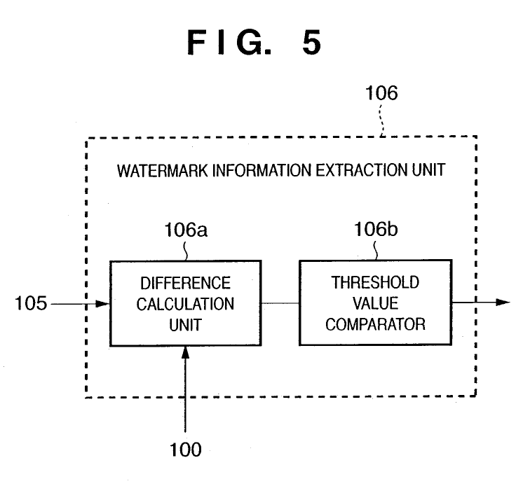

FIG. 5 is a block diagram illustrating the components of the watermark information extraction unit 106. As shown in FIG. 5, the watermark information extraction unit 106 includes a difference calculation unit 106a for calculating a difference component between a verification image and an original image, and a threshold value comparator 106b for comparing a freely set threshold value with the calculated difference component and outputting the bits of watermark information.

More specifically, the present invention is characterized by comprising input means (input unit 101) for inputting a document image (verification image 100) in which digital watermark information has been embedded; character recognition means (recognition processor 102) for recognizing each character image constituting the document image; and digital watermark detection means (watermark information extraction unit 106) for detecting the digital watermark information, which has been embedded in each character image constituting the document image, based upon a standard shape of each item of character information that has been recognized.

Further, the present invention is characterized by further comprising examination means (recognition processor 102) for checking each character image, which constitutes the document image, for a discrepancy with respect to the standard shape of each character image. Based upon any discrepancy checked by the examination means, the digital watermark detection means (watermark information extraction unit 106) detects digital watermark information that has been embedded in each character image constituting the document image.

The present invention further comprises character information storage means (recognition dictionary 103) for storing character recognition information that includes the features, character code numbers and font information of characters inclusive of a prescribed character. Utilizing character recognition information that has been stored in the character information storage means, the character recognition means (recognition processor 102) acquires character information that includes character code information and font information of a prescribed character contained in the document image, as well as information indicative of position in the document image.

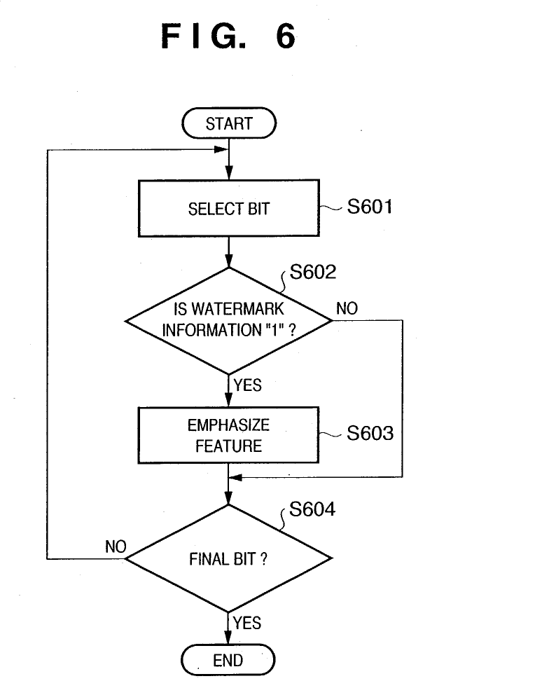

The operation of the watermark information extraction apparatus 1 according to the first embodiment having the above structure will now be described. The procedure for creating the verification image executed by the watermark information extraction apparatus 1 will be described first. In this embodiment, the verification image created by using the embedding method of varying a feature of part of a character in an original image is used. FIG. 6 is a flowchart useful in describing an example of a procedure for creating a verification image used in the first embodiment.

According to this embodiment, embedded watermark information is expressed as binary data comprising solely “0”s and “1”s. First, the initial bit of the watermark information is selected (step S601), then it is determined whether the selected bit of the watermark information is “1” (step S602). If the result of the determination is that this bit is “1” (“YES” at step S602), then feature emphasis is applied to the character of the original image in which this bit has been embedded (step S603). For example, processing is executed to lengthen the end of the radical of the character. If the bit is “0”, on the other hand (“NO at step S602), then it is construed that there has been no change in the original image. It should be noted that characters to undergo embedding may be successive characters, characters over an interval of several characters or characters at predetermined positions.

It is determined whether the bit is the final bit (step S604). If the result of the determination is that this bit is the final bit (“YES” at step S604), embedding processing is terminated. On the other hand, if the result of the determination is that this bit is not the final bit (“NO” at step S604), then control returns to step S601 and the bit embedded in the next character is selected. The above-described processing is executed up to the final bit of the watermark information. It should be noted that when the bit of embedded watermark information is “0”, it is possible to also shorten the line segment of a character.

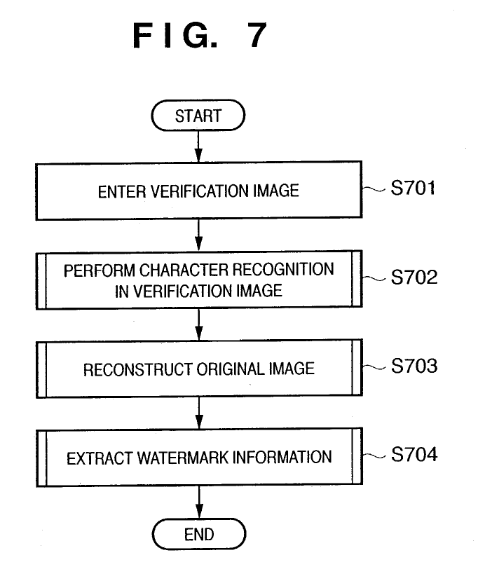

FIG. 7 is a flowchart useful in describing the operation of the watermark information extraction apparatus 1 according to the first embodiment. First, the verification image 100 is input to the recognition processor 102 via the input unit 101 (step S701). The verification image 100 input to the watermark information extraction apparatus 1 may be an image distributed via a communication line or an image read by a scanner, etc. Of course, the verification image 100 may be derived from a general page description language such as PostScript, PDF or TeX. The recognition processor 102 executes character recognition within the entered verification image 100 (step S702).

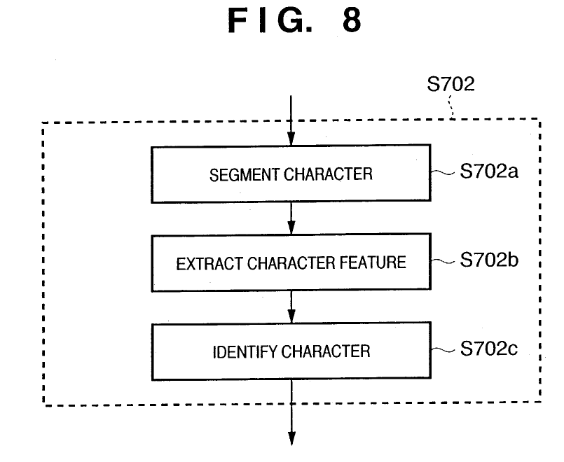

FIG. 8 is a flowchart useful in describing the operation of the recognition processor 102 shown in FIG. 7. The verification image 100 that has been input to the recognition processor 102 is applied to the character segmentation unit 102a, which segments a character in the verification image 100 using the circumscribed rectangle of the character as the unit of character recognition (step S702a). The circumscribed rectangle of a character is a rectangular figure circumscribing the character and may be found as follows:

Each pixel value of the verification image 100 is projected upon a vertical coordinate axis, a blank portion (a portion that is not a black character) is found, and line segmentation is performed by discriminating a line. This is followed by projecting the verification image 100 on the horizontal coordinate axis line by line, finding blank portions and performing segmentation character by character. This makes it possible to cut out each character at the circumscribed rectangle.

Next, character features are extracted by the feature extraction unit 102b using the circumscribed rectangle of a segmented character as the minimum unit (step S702b). Character feature extraction is an operation for extracting a prescribed feature, which is included in a character, in order to specifically identify a segmented character. As an example of a feature according to this embodiment, the area of a circumscribed rectangle of each character can be further segmented into small areas and a histogram of a direction component within the small area can be taken and used as the feature of the character or an imbalance in the distribution of pixel values can be adopted as the feature. Further, the center of the circumscribed rectangle is adopted as position information of the character.

The discriminator 102c compares the extracted feature and features possessed by characters or fonts stored in the recognition dictionary 103, thereby identifying the character or font (step S702c). The above-described processing makes it possible to obtain character code information, font information and character position information with regard to all characters contained in the verification image 100.

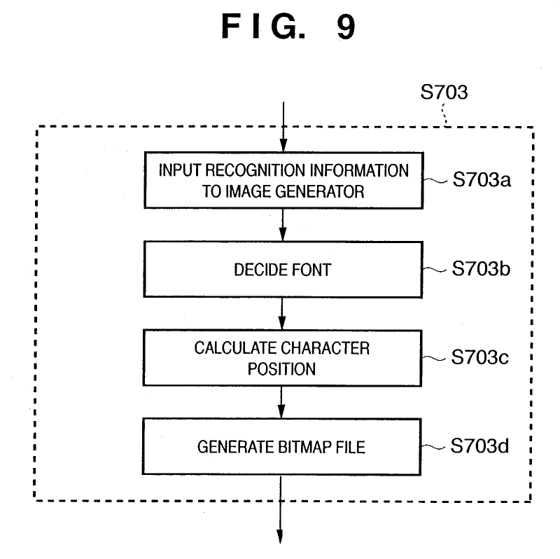

Based upon the obtained information relating to the character, the original image 105 is reconstructed by the original image reconstruction unit 104 (step S703). FIG. 9 is a flowchart useful in describing the operation of the original image reconstruction unit 104 according to the first embodiment. All of the input character code information 104a, font information 104b and character position information 104c in the verification image 100 is input to the image generator 104f in the original image reconstruction unit 104 (step S703a).

The image generator 104f decides which font of character font data 104d stored in the character font data 104e is to be used to perform reconstruction from the input character code information 104a and font information 104b (step S703b). Further, the position of the character in the original image is calculated from the character position information 104c that has been entered (step S703c). The original image 105 corresponding to the verification image 100 is generated as, e.g., a bitmap file (step S703d).

As described above, the original image 105 can be restored by the operation of the original image reconstruction unit 104 according to this embodiment and therefore it is unnecessary to store the original image is advance. Further, watermark information can be extracted utilizing the restored original image. Accordingly, in comparison with the conventional watermark information extraction apparatus using an original image, it is possible to obtain outstanding results, namely the fact that watermark information can be extracted with an accuracy equal to or better than that of the prior art.

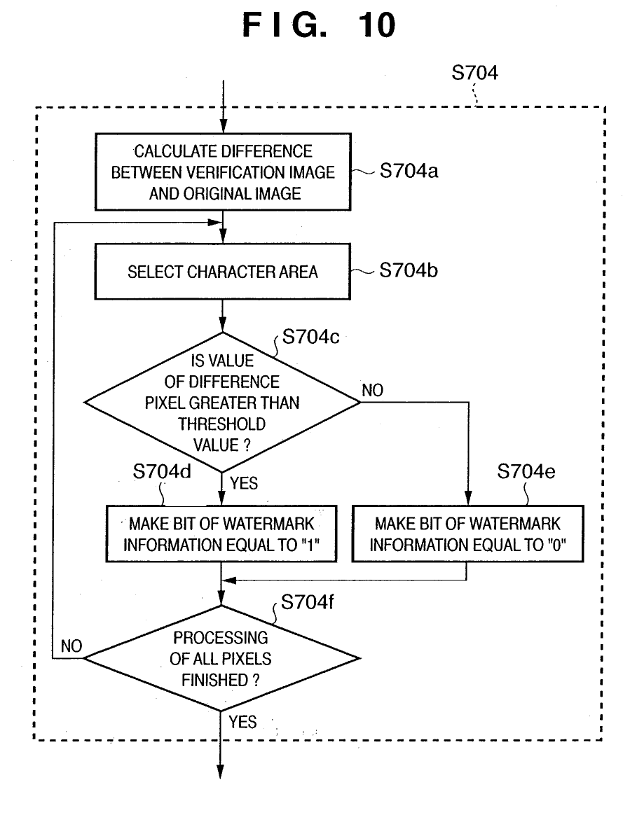

Thus, the verification image 100 and the restored original image 105 are input to the watermark information extraction unit 106, which proceeds to extract watermark information (step S114). On the basis of the difference component between the verification image 100 and the original image 105, the watermark information extraction unit 106 extracts the watermark information 107 that has been embedded in the verification image 100. FIG. 10 is a flowchart useful in describing the operation of the watermark information extraction unit 106.

First, the difference component between the verification image 100 and original image 105 is calculated (step S704a). The difference-component data is examined in order together with the circumscribed-rectangle information concerning the characters in the original image 105. A character to undergo discrimination is then selected (step S704b). Next, with regard to this character area (the area of the circumscribed rectangle), the difference component is compared with a predetermined threshold value (a boundary value on the quantity of black pixels) and it is determined whether the difference component exceeds the threshold value (step S704c). If the result is that the difference component is larger (“YES” at step S704c), then the watermark information bit is made “1” (step S704d). If the difference component is smaller (“NO” at step S704c), then the watermark information bit is made “0” (step S704e)

Specifically, if the radical of a character has been elongated in the embedding process, the difference component will be greater than the threshold value and therefore a “1” determination is made. If no change has been made, then a “0” determination is rendered. It is determined whether all pixels have been processed (step S704f). If the result is that the end of the document has been reached (“YES” at step S704f), then processing for extracting watermark information is exited. If the end of the document has not been reached (“NO” at step S704f), then control returns to step S114b and processing is resumed with regard to the next character.

<Second Embodiment>

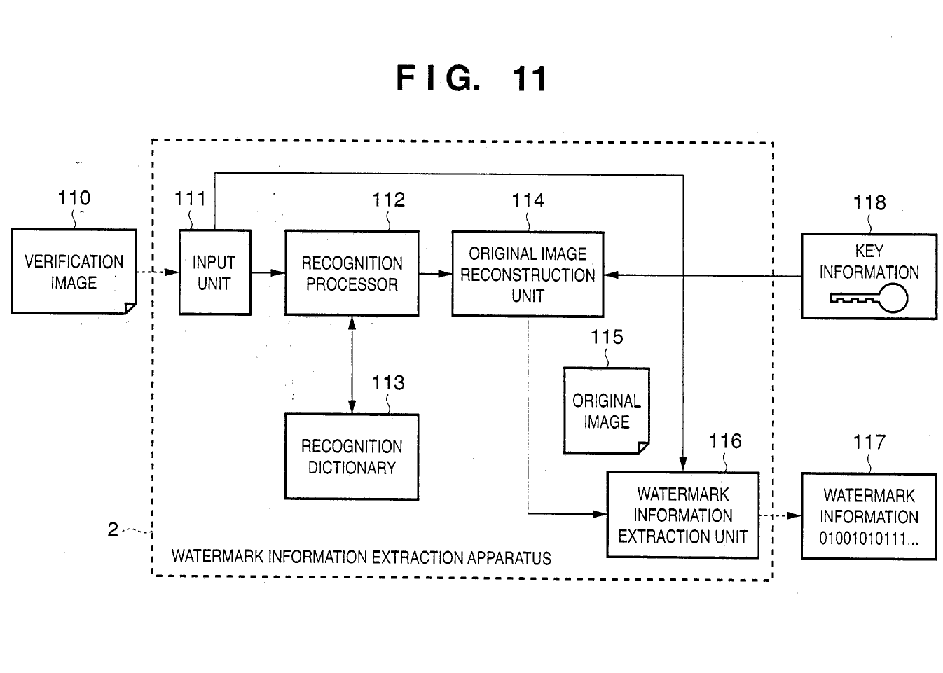

FIG. 11 is a block diagram illustrating the structure of a watermark information extraction apparatus 2 according to a second embodiment of the present invention. In FIG. 11, a verification image 110 is a document image in which watermark information 117 has been embedded in a certain document image by a digital watermark. The size of several characters in this document image has been changed. The watermark information extraction apparatus 2 according to this embodiment extracts the watermark information 117 from the verification image 110.

The watermark information extraction apparatus 2 according to the second embodiment comprises a recognition processor 112 for recognizing character code information, font information and character position information by performing character recognition within the verification image 110 entered from an input unit 101; a recognition dictionary 113, which is a dictionary used in character recognition performed by the recognition processor 111; an original image reconstruction unit 114 for generating an original image that prevailed prior to embedding of the watermark information 117 to be extracted based upon results of character recognition and key information 118; and a watermark information extraction unit 116 for extracting the watermark information 117 utilizing the entered verification image 110 and an original image 115 that has been generated. The key information 118 in this embodiment is assumed to be the size of a character in which watermark information has been embedded.

More specifically, the present invention is characterized by comprising input means (input unit 111) for inputting a document image (verification image 110) in which the watermark information 117 has been embedded by a digital watermark; character recognition means (recognition processor 112) for acquiring character information that includes character code information and font information of a prescribed character contained in the document image, as well as information indicative of position in the document image; document image reconstruction means (original image reconstruction unit 114) for reconstructing the document image (original image 115) that prevailed before the embedding of watermark information based upon the acquired character information and prescribed character size information; and watermark information extraction means (watermark information extraction unit 116) for extracting the watermark information 117 based upon result of comparison between the size of a prescribed character in the reconstructed document image and the size of a prescribed character in the document image in which watermark information has been embedded.

According to the present invention, the watermark information 117 is information to be embedded in a document image (original image 115) by a digital watermark that expresses a difference in bits by changing the size of a character. The watermark information extraction means (watermark information extraction unit 116) decides the bits of the watermark information 117 based upon the result of comparison between the size of a circumscribed quadrilateral of a prescribed character in the reconstructed document image (original image 115) and the size of a circumscribed quadrilateral of a prescribed character in the document image (verification image 110) in which watermark information has been embedded.

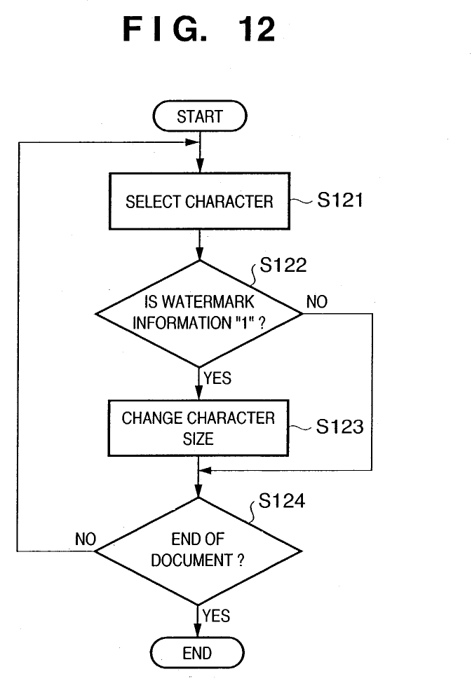

FIG. 12 is a flowchart useful in describing an example of a digital watermark embedding method that alters the relative size of a character in order to create the verification image 110. First, a character in which a watermark information bit is to be embedded is selected (step S121), then it is determined whether the bit of the watermark information to be embedded in this character is “1” (step S122). If the result of the determination is that this bit is “11” (“YES” at step S122), then the size of the character is changed (step S123). If the bit is “0”, on the other hand (“NO at step S122), then the size of the character is not changed. It should be noted that processing to reduce the size of the character may be executed if the bit of the watermark information to be embedded is “0”.

It is determined whether the character is the final character of the document (step S124). If the result of the determination is that this is the end of the document (“YES” at step S124), processing for embedding the bit of the watermark information is terminated. On the other hand, if the result of the determination is that this is not the end of the document (“NO” at step S124), then control returns to step S121 and the next character is selected. According to this embodiment, information relating to the size of a character in which watermark information has been embedded is stored as the key information 118.

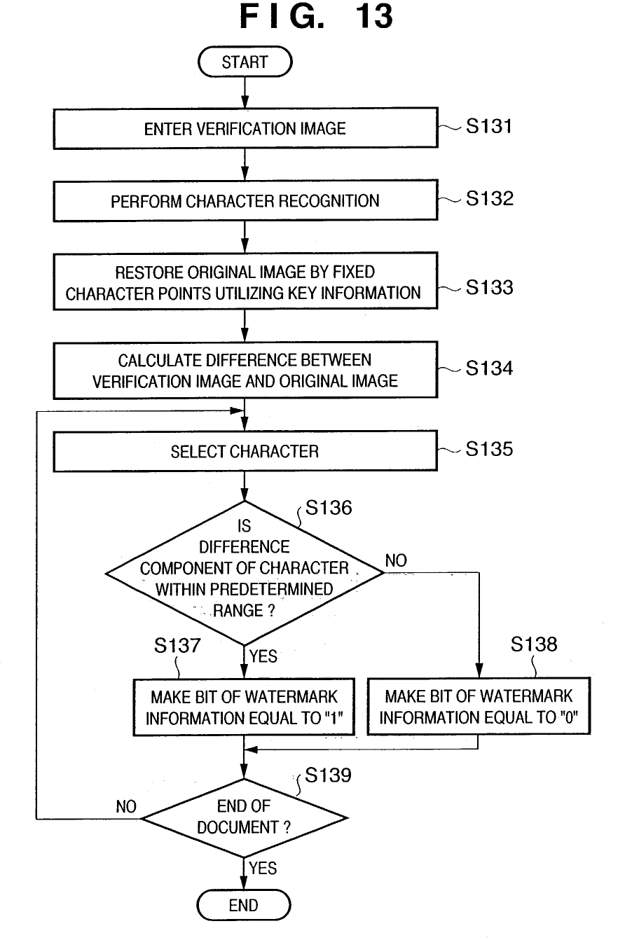

FIG. 13 is a flowchart useful in describing the operation of the watermark information extraction apparatus 2 having the above-described structure. First, the verification image 110 is input to the recognition processor 112 via the input unit 111 (step S131). The recognition processor 102 obtains character code information and font information using the recognition dictionary 113, in a manner similar to that of the first embodiment, and executes character recognition (step S132). Next, the original image reconstruction unit 114 restores the original image based upon information, which is related to the size of a character included in the key information 118 obtained by input of the key information 118 created together with the verification image 110, character code information and font information (step S133). For example, in a case where the size of the character in the key information 118 is 12 points, the original image 115 is reconstructed by characters of a fixed size, namely 12 points, based upon the obtained character code information and font information.

Next, on the basis of the rectangular information of the circumscribed character in the original image 115 and verification image 110, the watermark information extraction unit 116 calculates the difference component between the sizes of the respective characters (step S134). The initial character in the document is then selected (step S135). Next, it is determined whether the difference component of this character falls within a predetermined range (step S136). If the result of the determination is that the difference falls within the predetermined range (“YES” at step S136), then the bit of the watermark information is made “1” (step S137). On the other hand, if the difference is outside the predetermined range (“NO” at step S137), then the bit of the watermark information is made “0” (step S138).

The reason for excluding cases where the difference component is large is that generally a document is a collection of text that includes characters such as headings and footnotes of a size different from that of the characters in the main body of the document. Next, it is determined whether the end of the document has been reached (step S139). If the determination is that the end of the document has been reached (“YES” at step S139), extraction processing is terminated. On the other hand, if the determination is that the end of the document has not been reached (“NO” at step S139), then control returns to step S135, the next character is selected and the above-described processing continues.

<Third Embodiment>

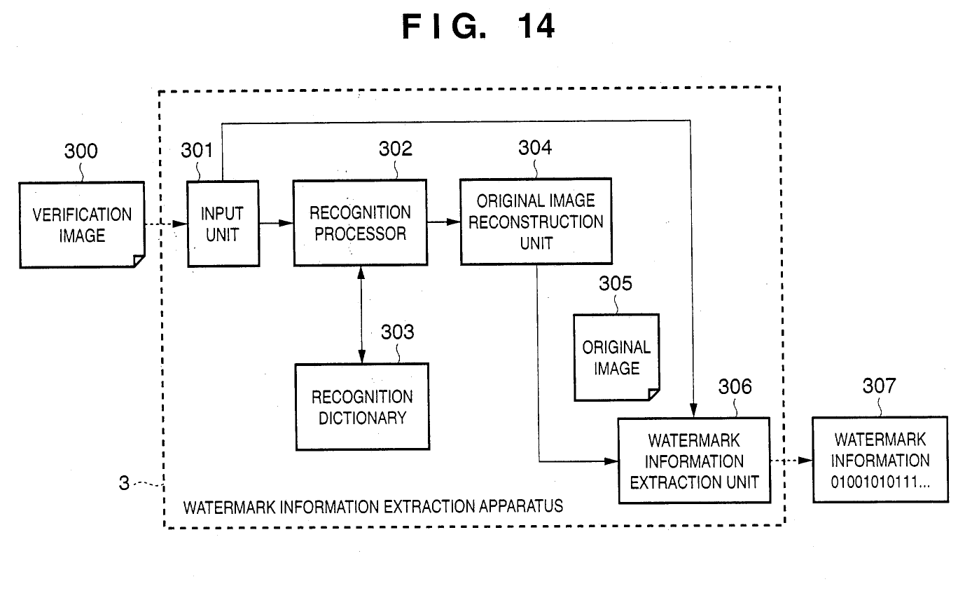

FIG. 14 is a block diagram illustrating the structure of a watermark information extraction apparatus 3 according to a third embodiment of the present invention. In FIG. 14, a verification image 300 is a document image in which watermark information 307 has been embedded in a certain document image by a digital watermark. The inclination of several characters in this document image has been changed. The watermark information extraction apparatus 3 according to this embodiment extracts the watermark information 307 from the verification image 300.

The watermark information extraction apparatus 3 according to the third embodiment comprises a recognition processor 302 for recognizing character code information, font information and character position information by performing character recognition within the verification image 300 entered from an input unit 301; a recognition dictionary 303, which is a dictionary used in character recognition performed by the recognition processor 302; an original image reconstruction unit 304 for generating an original image 305 that prevailed prior to embedding of the watermark information 307 to be extracted based upon results of character recognition; and a watermark information extraction unit 306 for extracting the watermark information 307 utilizing the entered verification image 300 and the original image 305 that has been generated.

More specifically, the present invention is characterized by comprising input means (input unit 301) for inputting a document image (verification image 300) in which the watermark information 307 has been embedded by a digital watermark; character recognition means (recognition processor 302) for acquiring character information that includes character code information and font information of a prescribed character contained in the document image, as well as information indicative of position in the document image; document image reconstruction means (original image reconstruction unit 304) for reconstructing the document image (original image 305) that prevailed before the embedding of watermark information based upon the acquired character information; and watermark information extraction means (watermark information extraction unit 306) for extracting the watermark information 307 based upon angle of inclination of a prescribed character in the reconstructed document image and the angle of inclination of a prescribed character in the document image in which watermark information has been embedded.

The present invention is characterized in that the watermark information extraction means (watermark information extraction unit 306) decides the bits of the watermark information 307 based upon the angle of inclination of a circumscribed quadrilateral of a prescribed character in the reconstructed document image (original image 305) and the angle of inclination of a circumscribed quadrilateral of a prescribed character in the document image (verification image 300) in which watermark information has been embedded.

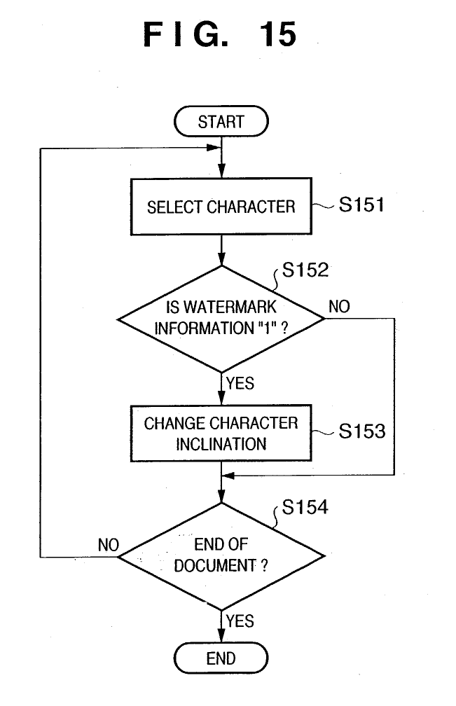

FIG. 15 is a flowchart useful in describing an example of a digital watermark embedding method that changes the inclination of a character for creating the verification image 300. First, the leading character in which a watermark information bit is to be embedded is selected (step S151), then it is determined whether the bit of the watermark information to be embedded in this character is “1” (step S152). If the result of the determination is that this bit is “1” (“YES” at step S152), then the inclination of the character is changed by rotating the character clockwise (step S153). If the bit is “0”, on the other hand (“NO at step S152), then the inclination of the character is not changed. It should be noted that processing to change the inclination of the character by rotating the character counter-clockwise may be executed if the bit of the watermark information to be embedded is “0”.

It is determined whether the character is the final character of the document (step S154). If the result of the determination is that this is the end of the document (“YES” at step S154), processing for embedding the bit of the watermark information is terminated. On the other hand, if the result of the determination is that this is not the end of the document (“NO” at step S154), then control returns to step S151 and the next character is selected.

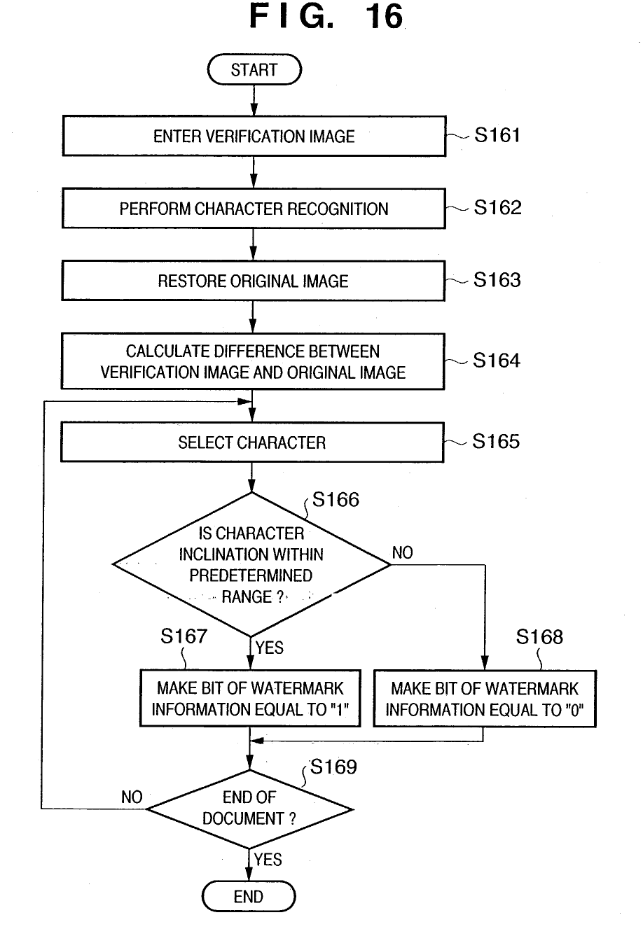

FIG. 16 is a flowchart useful in describing the operation of the watermark information extraction apparatus 3 having the above-described structure. First, the verification image 110 is input to the recognition processor 112 via the input unit 111 (step S161). The recognition processor 102 obtains character code information and font information using the recognition dictionary 303, in a manner similar to that of the first embodiment, and executes character recognition (step S162). Next, the original image reconstruction unit 304 restores the original image 305 based upon the character code information and font information (step S163).

Next, on the basis of the rectangular information of the circumscribed character in the original image 305 and verification image 300, the watermark information extraction unit 306 calculates the difference component between the sizes of the respective characters (step S164). The initial character in the document is then selected (step S165). Next, it is determined whether the difference component (the difference between the angles of inclination) regarding this character is greater than a predetermined threshold value (step S166). If the result of the determination is that the difference component is large (“YES” at step S166), then the bit of the watermark information is made “1” (step S167). On the other hand, if the difference is small (“NO” at step S166), then the bit of the watermark information is made “0” (step S168).

Next, it is determined whether the end of the document has been reached (step S169). If the determination is that the end of the document has been reached (“YES” at step S169), extraction processing is terminated. On the other hand, if the determination is that the end of the document has not been reached (“NO” at step S169), then control returns to step S165, the next character is selected and the above-described processing continues.

<Fourth Embodiment>

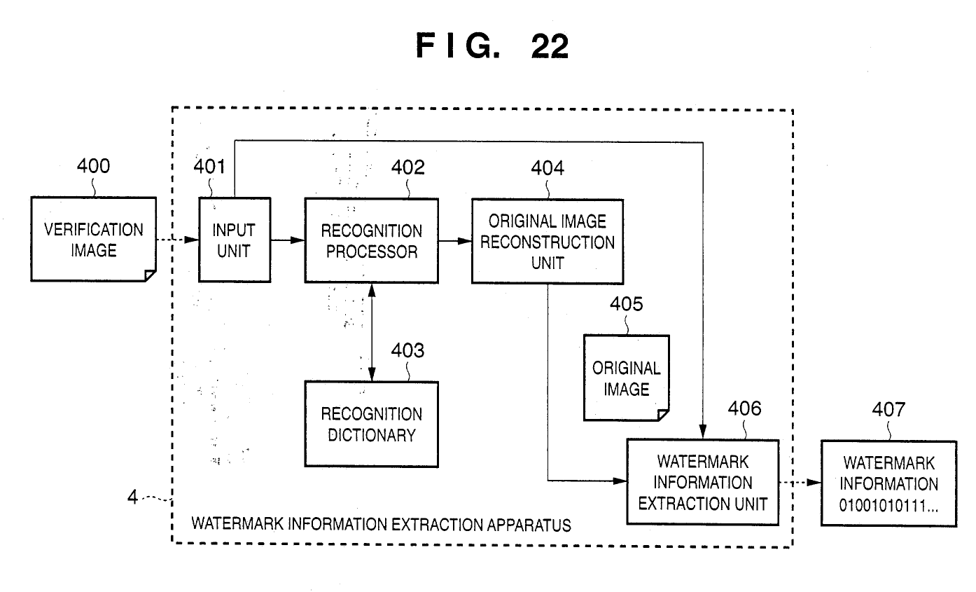

FIG. 22 is a block diagram illustrating the structure of a watermark information extraction apparatus 4 according to a fourth embodiment of the present invention. In FIG. 22, a verification image 400 is a document image in which watermark information 407 has been embedded in a certain document image by a digital watermark. The inclination of several characters in this document image has been changed. The watermark information extraction apparatus 4 according to this embodiment extracts the watermark information 307 from the verification image 400.

The watermark information extraction apparatus 4 according to the fourth embodiment comprises a recognition processor 402 for recognizing character code information, font information and character position information by performing character recognition within the verification image 400 entered from an input unit 401; a recognition dictionary 403, which is a dictionary used in character recognition performed by the recognition processor 402; an original image reconstruction unit 404 for generating an original image 305 that prevailed prior to embedding of the watermark information 407 to be extracted based upon results of character recognition; and a watermark information extraction unit 406 for extracting the watermark information 407 utilizing the entered verification image 400 and the original image 405 that has been generated.

More specifically, the present invention is characterized by comprising input means (input unit 401) for inputting a document image (verification image 400) in which the watermark information 407 has been embedded by a digital watermark; character recognition means (recognition processor 402) for acquiring character information that includes character code information and font information of a prescribed character contained in the document image, as well as information indicative of position in the document image; document image reconstruction means (original image reconstruction unit 404) for reconstructing the document image (original image 405) that prevailed before the embedding of watermark information based upon the acquired character information; and watermark information extraction means (watermark information extraction unit 406) for extracting the watermark information 407 based upon a discrepancy between the feature of part of a prescribed character in the reconstructed document image and the feature of part of a prescribed character in the document image in which watermark information has been embedded.

The present invention is characterized in that the watermark information extraction means (watermark information extraction unit 406) decides the bits of the watermark information 407 based upon a discrepancy between the feature of part of a circumscribed quadrilateral of a prescribed character in the reconstructed document image (original image 405) and a discrepancy between the feature of part of a prescribed character in the document image (verification image 400) in which watermark information has been embedded. It should be noted that the digital watermark may be embedded by a method other than that described above.

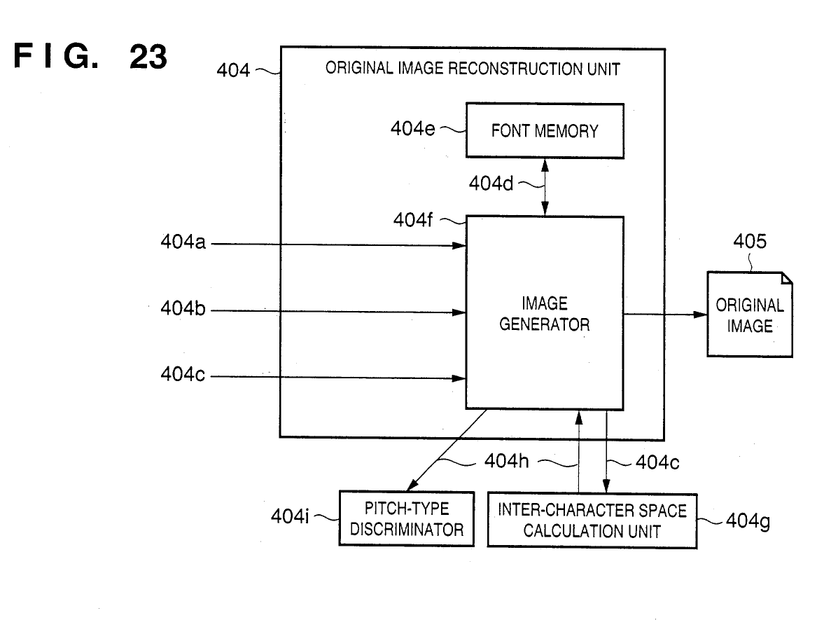

FIG. 23 is a block diagram illustrating the components of the original image reconstruction unit 404 according to the fourth embodiment. As shown in FIG. 23, the present invention is characterized in that the document image reconstruction means (original image reconstruction unit 404) decides whether the type of font is a monospaced font or proportional font using inter-character relationship parameter calculation means (an inter-character space calculation unit 404g) and pitch-type discrimination means (a pitch-type discriminator 404i). A method of determining whether a font is a monospaced font or a proportional font in an OCR technique is disclosed in the specification of Japanese Patent Application Laid-Open No. 08-050633.

An example of a method of embedding a digital watermark utilizing a character feature is that described in the first embodiment.

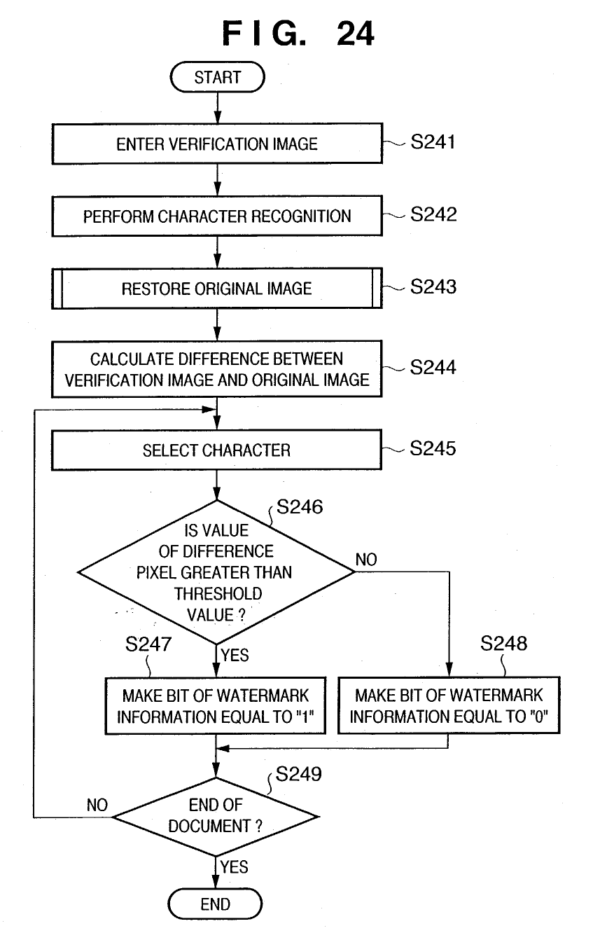

FIG. 24 is a flowchart useful in describing the operation of the watermark information extraction apparatus 4 according to the fourth embodiment having the above-described structure. First, the verification image 400 is input to the recognition processor 402 via the input unit 111 (step S241). The recognition processor 402 obtains character code information and font information using the recognition dictionary 403, in a manner similar to that of the first embodiment, and executes character recognition (step S242).

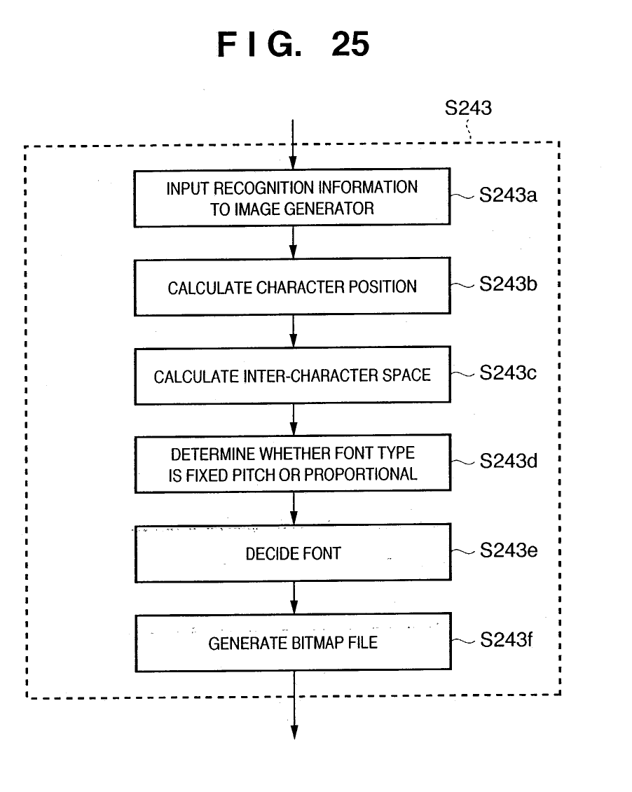

Next, the original image 405 is reconstructed by the original image reconstruction unit 404 based upon the information relating to the obtained character (step S243). FIG. 25 is a flowchart useful in describing the operation of the original image reconstruction unit 404 (the processing of step S243 in FIG. 24) according to the fourth embodiment. All character code information 404a, font information 404b and character position information 404c in the verification image 400 is input to an image generator 404f (step S243a).

The image generator 404f calculates the position of the character in the original image from the entered position information 404c of the character (step S243b). Next, the image generator 404f calculates inter-character space information 404h from the character position information 404c using the inter-character space calculation unit 404g (step S243c), and the pitch-type discriminator 404i determines whether the type of font is fixed pitch or proportional based upon the state of distribution of the space information (step S243d). Based upon the character code information 404a and font information 404b, it is decided which font of character font data 404d stored in a font memory 404e should be used for reconstruction (step S243e). The original image 405 corresponding to the verification image 400 is generated as, e.g., a bitmap file (step S243f).

When it is determined whether a font is a fixed-pitch font or a proportional font in this embodiment, the determination is made based upon the distribution of the space between characters. However, it should be obvious that the same effects are obtained even if use is made of the distribution of width of a circumscribed quadrilateral.

Next, on the basis of rectangular information of the circumscribed character in the original image 405 and verification image 400, the watermark information extraction unit 406 calculates the difference component between the sizes of the respective characters (step S244). The initial character in the document is then selected (step S245). Next, it is determined whether the difference component regarding this character falls within a predetermined range (step S246). If the result of the determination is that the difference component falls within the predetermined range (“YES” at step S246), then the bit of the watermark information is made “1” (step S247). On the other hand, if the difference falls outside the predetermined range (“NO” at step S246), then the bit of the watermark information is made “0” (step S248).

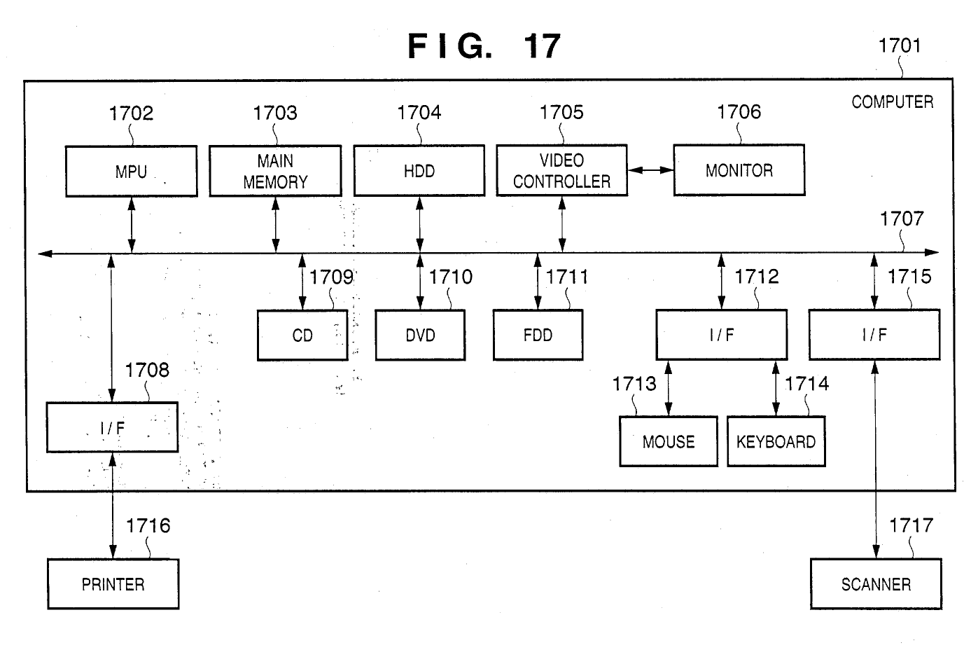

FIG. 17 is a diagram useful in describing the electrical structure of a watermark information extraction apparatus according to the four above-described embodiments of the present invention. It should be noted that it is not essential to use all of the functions of FIG. 17 to implement the watermark information extraction apparatus.

In FIG. 17, a computer 1701 is a generally available personal computer to which an image read out of an image input unit 1717 such as a scanner is input so that the image can be edited and archived. An image obtained by the image input unit 1717 can also be printed by a printer 1716. Various commands can be entered by the user by performing an input operation using a mouse 1713 and keyboard 1714.

Various blocks (described later) are connected within the computer 1701 by a bus 1707 and various data can be delivered between them. An MPU 1702 can control the operation of each block in the computer 1071 or execute a program stored internally. A main memory 1703 temporarily stores programs and image data to be processed in order that processing may be executed by the MPU 1702. A hard-disk drive (HDD) 1704 is a device in which programs and image data to be transferred to the main memory 1703, etc., are stored and is also used to archive image data after processing.

A scanner interface (I/F) 1715, which is connected to the scanner 1717 for reading documents and film or the like and generating image data, is capable of entering image data obtained by the scanner 1717. A printer interface 1708, which is connected to the printer 1716 that prints image data, is capable of transmitting the print image data to the printer 1716.

A CD drive 1709 is capable of reading in data that has been stored on a CD (CD-R/CD-RW), which is one type of external storage medium, or of writing data to the CD. A floppy-disk drive (FDD) 1711 is capable of reading and writing data from and to a floppy disk in a manner similar to that of the CD drive 1709. A DVD drive 1710 is capable of reading and writing data to and from a DVD in a manner similar to that of the FDD drive 1711. In a case where an image editing program or printer driver has been stored on a CD, floppy disk or DVD, these programs would be installed on the hard disk of the hard-disk drive 1704 and then transferred to the main memory 1703 as necessary.

In order that input commands from the mouse 1713 and keyboard 1714 may be received, an interface 1712 is connected to these devices. Further, a monitor 1706 is capable of displaying the results of processing for extracting watermark information as well as the progress of processing. A video controller 1705 is for transmitting display data to the monitor 1706.

The present invention can be applied to a system constituted by a plurality of devices (e.g., a host computer, interface, reader, printer, etc.) or to an apparatus comprising a single device (e.g., a copier or facsimile machine, etc.).

Furthermore, it goes without saying that the object of the invention is attained also by supplying a recording medium (or storage medium) storing the program codes of the software for performing the functions of the foregoing embodiments to a system or an apparatus, reading the program codes with a computer (e.g., a CPU or MPU) of the system or apparatus from the storage medium, and then executing the program codes. In this case, the program codes per se read from the storage medium implement the novel functions of the embodiments and the recording medium on which the program codes have been recorded constitutes the invention.

Furthermore, besides the case where the aforesaid functions according to the embodiments are implemented by executing the program codes read by a computer, it goes without saying that the present invention covers a case where an operating system or the like running on the computer performs a part of or the entire process in accordance with the designation of program codes and implements the functions according to the embodiment.

It goes without saying that the present invention further covers a case where, after the program codes read from the recording medium are written to a function expansion card inserted into the computer or to a memory provided in a function expansion unit connected to the computer, a CPU or the like contained in the function expansion card or function expansion unit performs a part of or the entire actual process in accordance with the designation of program codes and implements the functions of the above embodiments.

In a case where the present invention is applied to the above-described recording medium, program codes corresponding to the flowcharts described earlier are stored on this recording medium.

Thus, in accordance with the present invention as described above, watermark information can be extracted with an accuracy equal to or greater than that of the conventional technique, which performs extraction using an original image, without requiring use of an original image when extracting watermark information that has been embedded in an image by a digital watermark.

The present invention is not limited to the above embodiments and various changes and modifications can be made within the spirit and scope of the invention. Therefore, to apprise the public of the scope of the present invention, the following claims are made.

What is claimed is:

1. A watermark information extraction apparatus comprising:
input means for inputting a document image in which digital watermark information has been embedded;
character recognition means for recognizing each character image constituting the document image; and
digital watermark detection means for detecting the digital watermark information, which has been embedded in each character image constituting the document image, based upon a standard shape of each character that has been recognized.

2. The apparatus according to claim 1, further comprising examination means for checking each character image, which constitutes the document image, for a discrepancy with respect to the standard shape of each character image;
wherein said watermark information detection means detects digital watermark information, which has been embedded in each character image constituting the document image, based upon any discrepancy checked by said examination means.

3. A watermark information extraction apparatus comprising:
input means for inputting a document in which watermark information has been embedded by a digital watermark;
character recognition means for acquiring character information that includes character code information and font information of a prescribed character contained in the document image, as well as information indicative of position of the prescribed character in the document image;
document image reconstruction means for reconstructing a document image, which prevailed before the embedding of watermark information, based upon the character information acquired and prescribed character size information; and
watermark information extraction means for extracting the watermark information based upon result of comparison between size of the prescribed character in the reconstructed document image and the size of a prescribed character in the document image in which watermark information has been embedded.

4. The apparatus according to claim 3, wherein the watermark information is information to be embedded in a document image by a digital watermark that expresses a difference in bits by changing the size of a character; and
said watermark information extraction means decides the bits of the watermark information based upon the result of comparison between the size of a circumscribed quadrilateral of the prescribed character in the reconstructed document image and the size of a circumscribed quadrilateral of a prescribed character in the document image in which the watermark information has been embedded.

5. A watermark information extraction apparatus comprising:
input means for inputting a document in which watermark information has been embedded by a digital watermark;
character recognition means for acquiring character information that includes character code information and font information of a prescribed character contained in the document image, as well as information indicative of position of the prescribed character in the document image;
document image reconstruction means for reconstructing a document image, which prevailed before the embedding of watermark information, based upon the character information acquired; and
watermark information extraction means for extracting the watermark information based upon angle of inclination of the prescribed character in the reconstructed document image and angle of inclination of a prescribed character in the document image in which watermark information has been embedded.

6. The apparatus according to claim 5, wherein said watermark information extraction means decides bits of the watermark information based upon angle of inclination of a circumscribed quadrilateral of a prescribed character in the reconstructed document image and angle of inclination of a circumscribed quadrilateral of a prescribed character in the document image in which watermark information has been embedded.

7. The apparatus according to claim 3, further comprising character information storage means for storing character recognition information that includes features, character code numbers and font information of characters inclusive of the prescribed character;
wherein said character recognition means acquires character information that includes character code information and font information of a prescribed character contained in the document image, as well as information indicative of position of the prescribed character in the document image, utilizing character recognition information that has been stored in said character information storage means.

8. The apparatus according to claim 7, further comprising determination means for determining whether a font of the prescribed character included in the document image is a fixed-pitch font or proportional font based upon spacing of the prescribed character or size of a circumscribed quadrilateral of the prescribed character;
wherein said character recognition means acquires character information that includes, in addition to the font information, information indicating whether a font is a fixed-pitch font or proportional font based upon result of the determination performed by said determination means.

9. The apparatus according to claim 1, wherein auxiliary information is required as a key parameter in a case where a document is reconstructed or a case where a digital watermark is extracted.

10. A method of controlling a watermark information extraction apparatus for extracting digital watermark information from a document image in which the digital watermark information has been embedded, said method comprising:
a character recognition step of recognizing each character image constituting the document image; and
a digital watermark detection step of detecting the digital watermark information, which has been embedded in each character image constituting the document image, based upon a standard shape of each character that has been recognized.

11. The method according to claim 10, further comprising an examination step of checking each character image, which constitutes the document image, for a discrepancy with respect to the standard shape of each character image;
wherein said watermark information detection step detects digital watermark information, which has been embedded in each character image constituting the document image, based upon any discrepancy checked at said examination step.

12. A method of controlling a watermark information extraction apparatus for extracting watermark information from a document image in which the watermark information has been embedded by a digital watermark, said method comprising:
a character recognition step of acquiring character information that includes character code information and font information of a prescribed character contained in the document image, as well as information indicative of position of the prescribed character in the document image;
a document image reconstruction step of reconstructing a document image, which prevailed before the embedding of watermark information, based upon the character information acquired and prescribed character size information; and
a watermark information extraction step of extracting the watermark information based upon result of comparison between size of the prescribed character in the reconstructed document image and the size of a prescribed character in the document image in which watermark information has been embedded.

13. The method according to claim 12, wherein the watermark information is information to be embedded in a document image by a digital watermark that expresses a difference in bits by changing the size of a character; and
said watermark information extraction step decides the bits of the watermark information based upon the result of comparison between the size of a circumscribed quadrilateral of the prescribed character in the reconstructed document image and the size of a circumscribed quadrilateral of a prescribed character in the document image in which the watermark information has been embedded.

14. A method of controlling a watermark information extraction apparatus for extracting watermark information from a document image in which the watermark information has been embedded by a digital watermark, said method comprising:
a character recognition step of acquiring character information that includes character code information and font information of a prescribed character contained in the document image, as well as information indicative of position of the prescribed character in the document image;
a document image reconstruction step of reconstructing a document image, which prevailed before the embedding of watermark information, based upon the character information acquired; and
a watermark information extraction step of extracting the watermark information based upon angle of inclination of the prescribed character in the reconstructed document image and angle of inclination of a prescribed character in the document image in which watermark information has been embedded.

15. The method according to claim 14, wherein said watermark information extraction step decides bits of the watermark information based upon angle of inclination of a circumscribed quadrilateral of a prescribed character in the reconstructed document image and angle of inclination of a circumscribed quadrilateral of a prescribed character in the document image in which watermark information has been embedded.

16. The method according to claim 12, wherein the watermark information extraction apparatus has character information storage means for storing character recognition information that includes features, character code numbers and font information of characters inclusive of the prescribed character; and
said character recognition step acquires character information that includes character code information and font information of a prescribed character contained in the document image, as well as information indicative of position of the prescribed character in the document image, utilizing character recognition information that has been stored in said character information storage means.

17. The method according to claim 16, further comprising a determination step of determining whether a font of the prescribed character included in the document image is a fixed-pitch font or proportional font based upon spacing of the prescribed character or size of a circumscribed quadrilateral of the prescribed character;
wherein said character recognition step acquires character information that includes, in addition to the font information, information indicating whether a font is a fixed-pitch font or proportional font based upon result of the determination performed at said determination step.

18. The method according to claim 10, wherein auxiliary information is required as a key parameter in a case where a document is reconstructed or a case where a digital watermark is extracted.

19. A program for causing a computer to execute:
a character recognition procedure for recognizing each character image constituting a document image in which digital watermark has been embedded; and
a digital watermark detection procedure for detecting the digital watermark information, which has been embedded in each character image constituting the document image, based upon a standard shape of each character that has been recognized.

20. A recording medium on which the program set forth in claim 19 has been recorded.
